(19) United States
(12) Patent Application Publication
(10) Pub. No.: US 2017/0103485 A1
(43) Pub. Date: Apr. 13, 2017

(54) INTERACTIVE TOOLS FOR SEMANTIC ORGANIZATION OF LEGAL INFORMATION

(71) Applicants: ARIE MOSHE MICHELSOHN, WASHINGTON, DC (US); MICHAEL MALCOLM COSTA, Washington, DC (US)

(72) Inventors: ARIE MOSHE MICHELSOHN, WASHINGTON, DC (US); MICHAEL MALCOLM COSTA, Washington, DC (US)

(21) Appl. No.: 14/880,192

(22) Filed: Oct. 9, 2015

(51) Int. Cl. G06Q 50/18; G06F 17/30

(52) U.S. Cl. CPC G06Q 50/18; G06F 17/30896

(57) ABSTRACT

Novel curation and drafting tools for lawyers provide virtual lawyer workspaces, comprising interactive, data-visualizations rendered by single-page computer program, finite-state machine Applications, delivered in a web-Cloud environment, wherein said products represent, organize, and visualize legal information as semantic-legal data objects, and optionally provide for the creation of attorney work product therewith.

### CROSS-REFERENCE TO RELATED APPLICATIONS

This Application claims benefit to priority of a prior-filed Provisional Application, U.S. Ser. No. 62/062,825, filed Oct. 10, 2014.

### BRIEF SUMMARY OF THE INVENTION

Novel computer-program tools for lawyers are described herein, which include computer representations and visualizations of semantic-legal data-objects, template forms therefor, and attorney work product produced therewith, wherein said data-objects, template forms, and attorney work product are rendered on displays as interactive data visualizations by single-page, computer program Applications. The Applications employ a platform that provides for representations of legal information as semantic-legal data-objects, rendered as data-visualizations as further described herein. The data visualizations as described herein provide functionalities comprising input, storage, search, filter, display, and optional drafting functions, which enable semantic curation of legal information in semantic constructs that model lawyer work needs and workflow, and optional production of attorney work product therewith. Work product production may also be optionally collaborative and in real time, and subject to multi-tier security rules. The various aspects of the invention offer novel functionalities that together enable significant benefits and efficiencies to lawyers, law students, and the legal profession, over the prior art, in the representation, organization, analysis, storage, retrieval, filtering, and management of legal data, and its optional incorporation into legal work product, in a manner and on a scale not before possible using human labor, alone.

### BRIEF DESCRIPTION OF THE DRAWINGS

FIG. 1 is a screenshot of a rendering of an interactive ROAR Map.

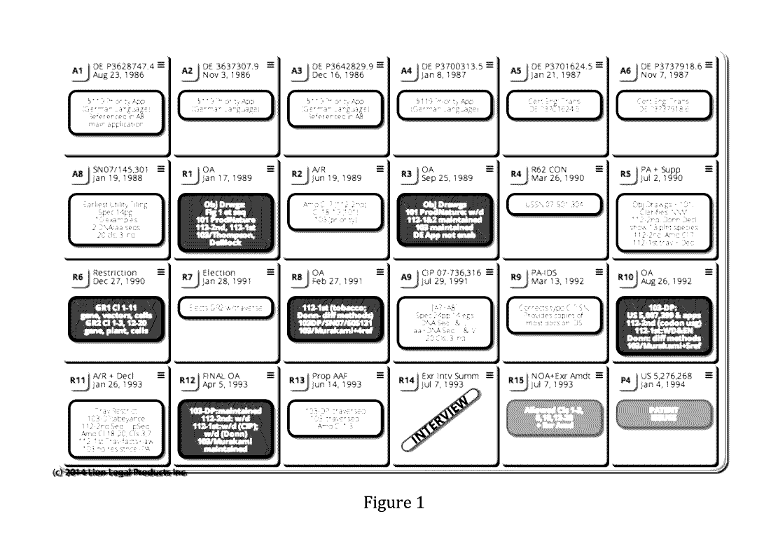

FIG. 2 is a screenshot of a rendering of an interactive ROAR Map alongside a source document referred to therein.

FIG. 3 is a screenshot of a rendering of an interactive ROAR Map alongside a source document referred to therein, and further wherein a notepad is rendered alongside the source document, on which work product notes may be drafted by a user or users in collaboration.

FIG. 4 is a screenshot of a rendering of an interactive ROAR Map alongside a Digest of a source document referred to therein.

FIG. 5 is a screenshot of a rendering of a modal view of a source document referenced in an interactive ROAR Map, alongside a Digest of said source document.

### BACKGROUND OF THE INVENTION

Legal technology previously has been employed in document discovery and management systems and in data analytics, primarily using statistical methods that sift potentially relevant legal information from unstructured or partially structured information. However, the universe of potentially relevant information can be very large relative to the legal information a lawyer typically curates and relies on for analysis and production of legal work product, based on the legal issues, legal rules, evidentiary facts, and other legal constructs that may be associated in a particular legal matter; which curation, analysis, and work product production typically constitute a significant percentage, and sometimes the majority, of lawyer workflow.

In the domain of legal curation, especially, corporate legal departments and law firms have continued to rely on expensive, human lawyer capital for all or most of those functions, which has limited considerably the flexibility, consistency, uniformity, and capacity for semantic representation, organization, filtering, storage, retrieval, and controlled communication of legal information, and the ability to incorporate semantic-legal information directly into attorney work product. Such continued reliance, in the absence of available machine tools designed to provide such functionalities in a workspace designed for lawyers in a manner that models actual lawyer work needs and work flow, has resulted in significant inefficiencies in and problems associated with, for example, task repetition, inconsistent information tracking and storage, and performance variability; and generally the engagement of lawyer time for non-legal-judgment tasks capable of being performed at significantly lower cost by machines or by combination of non-lawyers and machines, working under appropriate lawyer supervision.

### DETAILED DESCRIPTION OF THE INVENTION

The problems described above may be solved using computer Applications developed according to the teachings of the invention as exemplified herein, which provide methods to standardize and configure computer software products as lawyer virtual workspaces, capable of interactive, semantic-legal curatorial and optional work product production functionalities that confer significant benefits and efficiencies that previously were not possible using human resources, alone.

The interactive SmartCard products of the invention are configured to provide interactive data-visualizations of semantic-legal data-objects, which may be used to populate and render interactive maps of legal processes, such as, for example, the prosecution history of a patent application. Lawyer-users of an Application within the scope of the invention, for example, can thus quickly and efficiently digest and understand the legal significance of the sequence of events that comprise the prosecution history of a patent. Lawyer-users also can interact with such data-visualizations using event listeners and buttons to call up individual source documents, as well as to draft or view digests or other work product alongside such source documents on the same screen. Lawyers also can selectively collaborate with other users in virtual real-time.

The invention is further described in the Examples that follow and in the Figures; it being understood that the Examples and Figures are exemplary and not intended to limit the scope of the invention with respect to any functionalities provided by the invention that may be achieved in view of the invention as described, using functionally-equivalent, alternative coding formats, variable names, data structures, display configurations, and the like.

### Example 1 Record Of Actions and Responses (“ROAR”) Map of Patent Prosecution History Merits Data

For each merits event in a prosecution history (including without limitation, Applications filed or relied on for priority, Restrictions, Elections, Office Actions, Amendments/Responses, Interviews, Appeal Briefs, Examiner's Answers, and the like), a semantic-legal data-object is stored in a semantic-legal DATA Template, of which the following template and instantiation thereof coded in JSON format is exemplary of functionalities within the scope of the invention, it being understood that the same or similar functionalities may also be achieved using alternative combinations of classes, attributes, variable names and so-forth depending on the particular use-case, and which may alternatively be coded using other coding formats known in the art having the same or similar properties as said JSON format, such as XML format.

DATA Template:

```
{
  ″class″ : STRING (APPLICANT | PTO | INTERVIEW | NOA),
  ″date″ : STRING DATE // format date is as follows: 1987-08-
21T12:00:01.000Z″,
  ″description″ : STRING,
  ″id″ : // format is autogenerated in hexadecimal format, e.g.,
″204b417fc895d949″,
  ″longname″ : TEXT STRING,
  ″media″ : URL,
  ″name″ : STRING,
  ″patentId″ : // format is autogenerated in hexadecimal format, e.g.,
″05062c9813de6977″,
  ″rid″ : STRING (A# | R#| P#),
  ″summary″ : [ {
    ″cite″ : PAGE NUMBER,
    ″text″ : TEXT STRING
  }]
}
```

DATA Instantiated Example:

```
{
  ″class″ : ″Applicant″,
  ″date″ : ″1987-08-21T12:00:01.000Z″,
  ″description″ : ″Earliest US Utility \nfiling; Cls 1-15″,
  ″id″: ″204b417fc895d949″,
  ″longname″ : ″Earliest US Utility Filing″,
  ″media″ :
″documents/5273894_A7.pdf#page=1&view=FitH&navpanes=0&
toolbar=0&statusbar=0#page=4″,
  ″name″ : ″Utility″,
  ″patentId″ : ″05062c9813de6977″,
  ″rid″ : ″A7″,
  ″summary″ : [ {
    ″cite″ : 1,
    ″text″ : ″The ′118 Application spans 15 pages and contains 3
Figures, 4 Examples. Section 119 priority is claimed to four German
Applications. The ′118 Application was filed with 15 claims, which span
the subject matter claimed in the four issued U.S. patents constituting the
Strauch patent estate.″
  }, {
    ″cite″ : 1,
    ″text″ : ″The 15 original claims include 1 independent claim
(claim 1) and 14 dependent claims, which together comprise 5 sets of three
claims each covering the following subject matter:″
  }, {
    ″cite″ : 1,
    ″text″ : ″Claims 1-3: PTC gene obtained through selection″
  }, {
    ″cite″ : 1,
    ″text″ : ″Claims 4-6: Process for production of PTC-resistant
plants with the genes of claims 1-3, respectively″
  }, {
    ″cite″ : 1,
    ″text″ : ″Claims 7-9: PTC resistance markers in bacteria including the
genes of claims 1-3, respectively″
  }, {
    ″cite″ : 1,
    ″text″ : ″Claims 10-12: PTC resistance markers in plant cells
including the genes of claims 1-3, respectively″
  }, {
    ″cite″ : 1,
    ″text″ : ″Claims 13-15: Process for selective acetylation of the L-
form of PTC using cells expressing the genes of claims 1-3, respectively.″
  } ]
}
```

### Example 2 Code Logic Process for Rendering Data-Visualization of ROAR Map Semantic-Legal Data-Objects, with Optional Side-by-Side Display of Source Documents, Digests, and Drafting Functions

A series of semantic-legal data-objects employing a DATA Template structure of Example 1, and representing an overview of a U.S. patent prosecution history, was rendered on a Macintosh computer display using code having a logic structure summarized below. Item 1 occurred upon a lawyer-user calling up the website, www.mypatentphd.com, which initiated browser loading of CSS and JS files required for the rendering.

The JavaScript files were coded in Angular.JS to provide a single-page Application as a finite state machine. The database was stored on and accessed via a Firebase server (Firebase servers are described on and accessible through the Firebase website, www.firebase.com). The directive used is provided in Example 3 below. The CSS class rules used are provided in Example 4 below. The entire code used for the rendering was committed to Github and deployed to a Firebase server. Sample screenshots therefrom are provided in the Figures as described herein.

1. HTML—HyperText Markup Language

—Read by the browser—tells the browser to load CSS (Cascading StyleSheet) and JS (JavaScript) files.

2. Browser JS instructions.

—Includes connecting to database & retrieving data in JavaScript Object Notation (JSON)

3. JS traverses the HTML document as a DOM—Document Object Model

4. Finds<roarmap></roarmap>recognizes as a custom directive.

5. Applies directive code.

6. Key functional piece: ‘ng-repeat=“even [record] in roarevents [data collection]”’

7. Paints the remaining code onscreen once for each and every record in the data set

8. Inserts the value of the respective key when encountering {{event.KEY}} where ‘event’ is the individual record, and the key is a unique (key, value) pair per JSON convention.

9. The browser then styles the presentation according to class rules described by the CSS.

10. This same process is repeated with the templates for additional states, including DOCUMENT, DOCUMENT/NOTEPAD, DIGEST/DETAILS and DIALOG/MODAL states. These states are activated by the links described by the anchor <a> tags inside the ROARmap template, at a user's option.

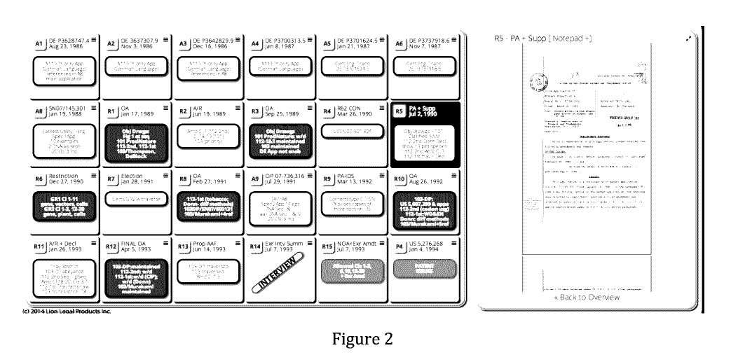

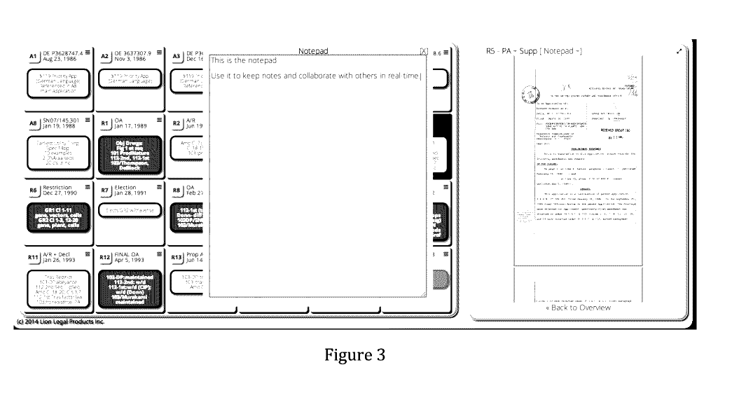

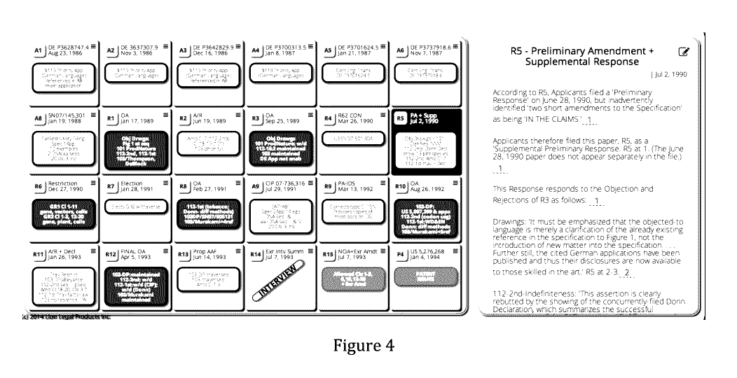

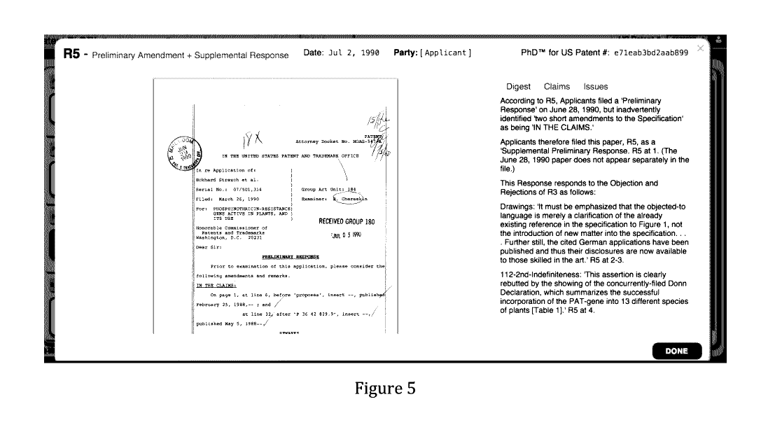

The DOCUMENT, DOCUMENT/NOTEPAD, DIGEST/DETAILS, and DIALOG/MODAL states are exemplified in the renderings for which screenshots are provided as FIGS. 2-5 respectively. Source documents (Document state) may be called up by a user by clicking on the “R#” box at the top left of each ROAR Map element. Digest/Details may be called up by a user by clicking on the center colored border region containing a high-level summary of the event. Document/Notepad may be called up by a user clicking on the Notepad+icon in the document source window. Dialog/Modal may be called up by a user clicking on the three-line icon at the top right of each ROAR map element.

### Example 3 Angular.JS Directive for Rendering a ROAR Map Display

```
angular.module(′roarmap′).directive(′roarmap′, [′$stateParams′, function
($stateParams) {
      return {
    restrict: ′EA′
    //require: ′\hat{ }roarevents′,
    transclude: true,
    scope: true,
    controller: [ ′$firebase′, ′$scope′, ′$state′, ′$stateParams′, function
($firebase, $scope, $state, $stateParams) {
                var sync = $firebase(new
Firebase(′https://patentphd.firebaseio.com/roarevents′));
                var ROARevents = sync.$asArray( );
                $scope.ROARevents = ROARevents;
                $scope.updateRoar = function ( ) {
                    ROARevent.save($scope.event);
                  };
            }],
    template: ′<div class=″container-fluid″>′ +
    ′<div class=″row″>′ +
      ′<div class=″col-xs-30″>′ +
      ′<div class=panel sub-independent reventlist clearfix repeat-
animation″>′ +
        ′<div my-widget class=″reventlist″ ng repeat=″event in ROARevents |
filter: $stateParams.patentId | orderBy: [\′date\′,
\′rid\′] ″ >′ +
          ′<div ui-sref-active=″active″ ng-class=″{active:
$stateParams.eventId == event.$id}″ class=″info″ ng-
controller=″RoarMapDetailCtrl″>′ +
            ′<div class=″rflag″ style=″z-index: 0;″>′ +
              ′<h6>{{event.name}}<br>{{event.date | date}}</h6>′ +
            ′</div>′ +
            ′<button class=″pull-left bth btn-flat rbutton ttip″ ui-
sref=″.document({eventId: event.$id})″ popover=″view {{event.name}}.pdf″
popover-trigger=″mouseenter″ popover-animation=″true″ popover-
placement=″right″ popover-popup-delay=″500ms″>{{event.rid}}
</button>′ +
            ′<button type=″button″ class=″btn btn-flat pull-right fa fa-bars″
style=″font-size: 10px;padding: 0px; color: #006699; margin: 0px;position:
absolute; top: 4px.; right: 4px; background-color: rgba(0,0,0,0.05);width:
15px; height: 15px;float: right;″ ng-dialog=″xlDialogId″ ng-dialog-
controller=″InsideCtrl″ ng-dialog-data=″{{event}}″ ng-dialog-class=″ngdialog-
theme-xl″ ng-dialog-show-close=″true″></button>′ +
            ′<a ui-sref=″.detail({eventId: event.$id})″>′ +
              ′<div class=″{{event.class}}″ >′ +
                ′<pre>{{event.description}}</pre>′ +
                ′</div>′ +
              ′</a>′ +
          ′</div><!--info-->′ +
        ′</div><!--ng-repeat-->′ +
      ′</div><!--panel-->′ +
    ′</div><!--column-->′ +
  ′</div><!--row-->′ +
′</div><!--container-->′,
    link: function(scope, iElement, iAttrs, ctrl) {
    }
  };
}])
.directive(″myWidget″, function( ) {
  var linkFunction = function(scope, element, attributes) {
    var paragraph = element.children( )[0];
    $(paragraph).on(″mouseenter″, function( ) {
      $(this).css({ ″background-color″: ″rgba(0,150,200,.75)″ }).css({″z-
index″: 100});
    });
    $(paragraph).on(″mouseleave″, function( ) {
      $(this).css({ ″background-color″: ″″ }).css({″z-index″: ″″});
    });
  };
  return {
    restrict: ″EA″,
    link: linkFunction
  };
});
```

### Example 4 LESS/CSS STYLESHEET for Rendering a ROAR Map Display

```
/* Styles */
@cardsize: 90%;
.summarybox2d( ){
            position: absolute;
            top: 40px;
            width: @cardsize;
            height: auto;
            max-height: 70px;
            padding: 4px;
            overflow: hidden;
            margin: 0%;
            border radius: 10px;
            & pre {padding: 2px; margin: 0px;font-size: 0.9em;
background: none; border: 0px solid white;line-height: lem;}
}
//R-Event Things
.reventlist{
      font-size: 10px;
      div {& *{transition: all 0.5s easeout;transform-style:
      preserve-3d;}}
        .info{
            display: block;
            float: left;
            position: relative;
            margin-left: 0.33%;
            margin-top: 0.25em;
            padding: 0.5em;
            width: ((100%/6.15));
            height: 120px;
            border: 0px solid #cccccc;
            box-shadow: inset −2px −2px 4px #000000;
            border-radius: 5px;
            background-color: rgba(241, 235, 213, 0.75);
}
      .active{ transition: all 0.25s linear; color: white; background-color:
rgb(0,150,200);/*background-image: linear-gradient (top,
        rgba(14, 114, 183, 1.000),
        rgba(119, 188, 244, 1.000));*/
        & h6{color: white;font-weight: 400;}
        & .rbutton{border: 0px solid ; box-shadow: 2px 2px 5px black;
font-weight: 700; color: rgb(0,150,200);}
        }
        & a{color: rgba(100,30,32,1); line-height: 0em;}
      & a:hover{color: rgba(200,30,32,1); text-decoration: none;}
      & h6{margin-top: 0px;}
      & .rbutton {
            position: absolute;
            top: 5px;
            left: 5px;
            float: left;
            height: 24px;
            width: 24px;
            font-size: 1em;
            font-weight: 900 !important;
            background-color: rgba(254, 203, 166,1);
            border: 1px solid rgba(254, 217, 190,1);
            vertical-align: top;
            text-align: center;
            border-radius: 5px;
            .box-shadow(~″2px 2px 2px rgba(0, 0, 0, 0.5)″);
            padding: 0px;
              }
    & .rbutton:hover{.box-shadow(~″inset 1px 1px 3px rgba(0, 0, 0,
0.498039)″);}
      & .rflag {
            position: relative;
            left: 30px;
            top: 2px;
            width: 75%;
            text-align: left;
            vertical-align: top;
            & h6{font-size: 1em; line-height: 1em; }
      }
      & .PTO {
            .summarybox2d( );
            .box-shadow(~″2px 2px 5px rgba(0, 0, 0, 0.498039)″);
            border: 3px solid rgb(100, 0, 2);
            background-color: RGBA(200, 30, 32, .7);
            & pre{font-weight: 700; color: #fff;)
      }
      & .PTO:hover{.box-shadow(~″inset 2px 2px 5px rgba(0, 0, 0,
0.498039)″);}
      & .Applicant {
        .summarvbox2d( );
            .box-shadow(~″2px 2px 5px rgba(0, 0, 0, 0.498039)″);
            color: rgb(0, 80, 215);
            border: 3px solid rgb(0, 80, 215);
            background-color: rgb(255, 255, 255, 1);
      }
      & .Applicant:hover{.box-shadow(~″inset 2px 2px 5px rgba(0, 0, 0,
0.498039)″);}
      & .NOA {
            .summarybox2d( );
            .box-shadow(~″2px 2px 5px rgba(0, 0, 0, 0.498039)″);
            border: 2px solid rgb(124, 153, 79, 1);
            background-color: rgba(124, 153, 79, 0.65);
            & pre{font-weight: 700;color: #FFFFFF;}
      }
      & .NOA:hover{.box-shadow(~″inset 2px 2px 5px rgba(0, 0, 0,
0.498039)″);}
      & .Interview {
            .summarybox2d( );
            .box-shadow(~″2px 2px 5px rgba(0, 0, 0, 0.498039)″);
            border: 2px solid rgb(125, 125, 125, 1);
            background-color: rgba(240, 240, 240, 0.5);
            transform: rotateZ(−38deg) translateY(10px)
            translateX(−15px)
!important;
            & pre {display: none; padding: 0px; margin: 5px;font-size:
1.1em;}
      }
      & .Interview:hover{.box-shadow(~″inset 2px 2px 5px rgba(0, 0, 0,
0.498039)″);}
      & .Interview:after{content: ″INTERVIEW″; font-weight: 900;
font-size: 1.5em;}
}
}
```

We claim:

1. A computer program method for data-visualization of a patent prosecution history, comprising:
storing a series of prosecution history events in a database as a set of records comprising semantic-legal data-objects having data structures defined by a data-object template in which said events are categorized according to a set of event classes;
storing a set of JavaScript files, Cascading StyleSheets, source files, and HTML document files in a database accessible to a remote user upon request through connection to a website via a web browser;
said HTML document files comprising a custom directive with instructions for retrieval and rendering of said semantic-legal data-objects; and a set of anchor tags comprising links to invoke one or more views of said semantic-legal data objects at a user's discretion;
said Cascading StyleSheets comprising a set of styling rules corresponding to said set of event classes;
serving said JavaScript files, Cascading StyleSheets, source files, and HTML document files to a remote user upon request; and
rendering said semantic-legal data-objects according to the instructions and rules contained in said JavaScript files, Cascading StyleSheets, and HTML document files, on a computer screen display.
